(19) United States
(12) Patent Application Publication
(10) Pub. No.: US 2006/0177636 A1
(43) Pub. Date: Aug. 10, 2006

(54) Printed strip-type materials especially for covering containers

(76) Inventor: Peter Reich, Pirk (DE)

Correspondence Address: WENDEROTH, LIND & PONACK, L.L.P., 2033 K STREET N. W., SUITE 800, WASHINGTON, DC, 20006-1021, US

(21) Appl. No.: 10/564,993

(22) PCT Filed: Aug. 4, 2004
(86) PCT No.: PCT/EP04/08736

§ 371 Date: Mar. 1, 2006

(30) Foreign Application Priority Data
Aug. 5, 2003 (DE) 203 12 066.3

(51) Int. Cl. B41M 5/00

(52) U.S. Cl. 428/195.1

(57) ABSTRACT

The invention relates to printed strip-type materials, especially for covering containers, possible imprints being applied to the side opposing the filler and/or to the side facing the filler by means of digital printing.

The invention relates to imprinted sheet materials, in particular for coverings of containers.

Covering materials of containers in general are comprised of composites comprising metal and/or synthetic films and/or paper or aluminum foils and, in general, are imprinted. This imprint may be applied on the outside as well as also on the side facing the fill good.

If containers are to be used, which are provided with such coverings having imprints on the side facing the packaged fill good, in which sensitive goods, for example food items, infant food, animal feed, pharmaceutical or cosmetic preparations are to be packaged, legal regulations must be taken into consideration. The printing inks utilized must be harmless when coming into contact with the packaged foods. However, only very few printing inks fulfill these requirements, such that the spectrum of colors which can be employed is highly restricted.

However, if the printing ink is separated from the packaged good by a barrier layer, a very large number of known printing inks can be utilized. Such a barrier layer can be, for example, a heat-seal lacquer, which, in the case of imprints produced with a gravure, flexographic or screen print process, can be applied directly onto the print.

With an imprint on the side facing away from the fill good, in contrast, the harmlessness of the printing inks is not absolutely of decisive importance. It is understood that the printing inks must not be toxic or harmful to health. However, the critical issue in this case is the temperature stability of the printing inks.

During the sealing of the covering, temperatures of approximately 120 to 300° C. are employed. Printing inks, in particular printing inks which can be used in digital print processes, are generally only stable up to temperatures of 100° C.

EP 1 258 859 A1 discloses an imprinted sheet material for container coverings with an imprint produced in digital printing and is prepared such that it is heat stable, wherein onto an adhesion promoter applied on a carrier sheet the imprint is applied, which subsequently is coated over with a lacquer comprising a curing agent or a separately applied curing agent and thus becomes stabilized against temperature effects such that, subsequently, sealing can be carried out with the aid of an appropriate heat-seal lacquer. The imprint is thereby stabilized over the entire area.

However, it is only possible with difficulties, if at all, to apply after the sealing or packaging process a further imprinting onto the material imprinted and stabilized over the entire surface according to EP 1 258 859 A, since after the application of the stabilizing lacquer, the surface can only be imprinted with difficulty and the printing ink adheres poorly, if at all, on the stabilized material.

The aim of the invention is therefore to provide an imprinted sheet material, which has imprinting produced in the digital print process, with the imprinted material capable of being heat-sealed, and which continues to remain imprintable after the packaging or heat-sealing process.

Subject matter of the invention is therefore an imprinted sheet material for container coverings, characterized in that on the outside of a carrier sheet a thermoplastic adhesion promoter is applied, subsequently the appropriate imprint is applied, whereupon onto the imprint a lacquer of similar composition is applied in those regions, in which heat protection is required, by means of a register-controlled method, a portion of the curing agent contained in the lacquer or of a separately applied curing agent migrates into the printing ink or the adhesion promoter leading to cross-linking and/or on the side facing the fill good an adhesion promoter and thereon an imprint are applied, whereupon onto the printing ink an adhesion promoter and in the above defined regions a heat-seal lacquer is applied.

In one embodiment the adhesion promoter is applied over the entire area of the carrier substrate. However, in a further embodiment the adhesion promoter is only applied in those regions in which the imprinting is to be carried out utilizing the digital process. This partial application also takes place with a register-controlled process.

Carrier substrates to be considered are, for example, carrier films, preferably flexible synthetic films, comprised for example of PI, PPS, PEEK, PEK, PEI, PSU, PAEK, LCP, PEN, PBT, PET, PA, PC, COC. The carrier films have preferably a thickness of 5-700 μm, preferred is a thickness of 5-200 μm and especially preferred 5-90 μm.

As carrier substrates can further serve metal foils, in particular Al foils having a thickness of 5-200 μm, preferably 10 to 110 μm, especially preferred is a thickness of 20-90 μm. The foils can also be surface-treated, coated or laminated, for example with synthetic material, or they can be lacquered.

As carrier substrates can further also be employed paper or composites with paper, for example composites with synthetic material with a weight per unit area of 20-500 g/m², preferably of 40-200 g/m^{2.}

Appropriate synthetic material-metal or paper-metal composites as well as also multi-layered composites can also be utilized as carrier material. Aluminum foils or metallized polyester films are preferably utilized.

Onto the visible side of the carrier sheet a thermoplastic adhesion promoter is applied. The thermoplastic adhesion promoter is preferably an ethylene acrylate copolymer dispersion with an average molecular weight of approximately 22,000-150,000 or a mixture of this dispersion with a polyester, polyvinyl acetate, polyacrylate or polyamide. The mixing ratio can here be 9:1 to 1:1 with respect to the ethylene acrylate copolymer. The thermoplastic adhesion promoter in general has a softening point of approximately 60-100° C.

The thermoplastic adhesion promoter can preferably be pigmented. The thermoplastic adhesion promoter preferably contains a white pigment, with all known pigments of this type being utilizable. Due to the pigmentation, imprinting the entire surface can optionally be omitted.

Employing a conventional print process and/or a digital print process, preferably the Indigo process, the appropriate imprint is subsequently applied and registration and control marks are printed simultaneously.

This layer is subsequently provided with a lacquer coating, the lacquer having a composition similar or identical to the thermoplastic adhesion promoter.

The coating lacquer may already comprise 0.5%-10% of a curing agent, for example a polyfunctional aziridine or a melamine resin. If this lacquer does not contain curing agents, the curing agent can be applied separately after the coating lacquer has been applied.

The curing agent migrates into the printing ink and into the thermoplastic primer applied on the carrier sheet and forms cross-linkages.

The thermoplastic system, which has a relatively low softening temperature, thereby becomes heat stable. In general, a heat stability of at least 250° C., preferably more than 280° C., is attained.

The migration and cross-linking is time-dependent and, at ambient temperature, may be approximately 24 to 96 hours. Acceleration of the curing process is also possible by tempering.

The application of the overcoat lacquer takes place under register and gage-pin precision with respect to the imprint applied in digital printing.

A flexible material sheet, modifiable in the longitudinal and/or transverse direction and provided with the defined imprint with registration marks and control lines, is therein measured longitudinally between two or more registration marks via a preceding measuring device and adjusted to the necessary register length between two or more actuated tensioning assemblies. Under the control of a control circuit, in particular a register control, the material sheet is subsequently inserted under register control via a register roller ahead of the first printing unit. The side register is driven forward via a sheet control and inserted via a pivoting frame, whereupon the material sheet is imprinted with one or several functional or decorative layers with gage-pin and register control with respect to the optionally previously applied coating on the material sheet.

The previously imprinted material sheet has registration marks and control lines, which are measured inline by means of optical sensors in order to determine the precise register distances.

If the distance between the registration marks is greater than the requisite register length, the imprinted material sheet is pre-shrunk to the required length through heating by means of an IR drier, a heating cylinder or a convection drier. If the distance between the registration marks is less than the required register length, the imprinted material sheet is suitably stretched to the appropriate length between two tensioning assemblies or several times in succession with several tensioning assemblies.

Before the first printing unit the material sheet adjusted in this manner to the appropriate length is subsequently inserted via a register roller. The correct insertion takes place in the side register via a sheet control or via a pivoting frame, respectively, as well as via a displaceable cylinder. The print process is subsequently carried out under longitudinal and side register control.

This method permits applying within extremely narrow tolerances several layers with register precision in longitudinal as well as also side register on the front as well as also on the back side, optionally while utilizing a reversing station.

Due to the heat stability which has now been obtained in the defined regions, conventional heat-seal lacquers can subsequently be utilized in order to close containers tightly with the material sheets according to the invention, optionally after cutting the sheet to size. The heat-seal lacquer is no longer applied over the entire surface but rather only in those regions in which the sealing or the packaging takes place. This can also be accomplished with the above described method.

In contrast to the heat-stabilized regions, the regions not provided with the overcoat lacquer are still imprintable even after the heat-sealing process. Such imprinting during or after the packaging process serve in general for the identifiability of the packaging date, the content, and also of the shelf life of the packaged product.

The thermoplastic adhesion promoter, the overcoat lacquer and optionally the curing agent can be applied with any suitable coating method, such as a print process, for example screen, gravure or flexographic process, roller application method and the like.

The imprint can be applied utilizing any known print technology, such as the screen, gravure, digital, offset or flexographic print process, preferably the digital print process, for example the Indigo process.

On the back side of the carrier sheet an adhesion promoter is applied. The adhesion promoter is preferably an ethylene acrylate copolymer dispersion with an average molecular weight of approximately 22,000 to 150,000 or a mixture of this dispersion with a polyester, polyvinyl acetate, ethyl vinyl alcohol, polyacrylate or polyamide. The mixing ratio can here be 9:1 to 1:1 with respect to the ethylene acrylate copolymer. The thermoplastic adhesion promoter in general has a softening point of approximately 60-100° C.

The desired imprint is subsequently applied utilizing a known print process, such as the screen, gravure, digital, offset, inkjet, thermal transfer, sublimation or flexographic print process, preferably the digital print process, for example the Indigo process.

A heat-seal lacquer is subsequently applied onto the imprint. Suitable are known heat-seal lacquers with different sealing properties, which are capable of sealing synthetic materials, such as PS, PP, PE, or PET.

To improve the adhesion of the heat-seal lacquer on the imprinted carrier film, an adhesion promoter can optionally be applied before the application of the heat-seal lacquer. This is in particular advantageous if the Indigo process has been employed to produce the imprint.

As the adhesion promoter a polyester-melamine resin mixture in a solvent base is preferably employed and the ratio of polyester fraction:melamine resin fraction can be approximately 2:1 to 3:1.

The inventive imprinted sheet materials are utilized in particular for container coverings, in particular for containers for food items, such as dairy products, fruit and vegetable juices, animal feed and animal care items, pharmaceutical and/or cosmetic products, cleaning agents, chemicals and the like. For this purpose the sheet materials are stamped in known manner to improve their separability and are cut-to-size into the appropriate formats, for example by cutting, punching and the like.

### EXAMPLES

### Example 1

To produce a container covering capable of being heat-sealed, onto a metallized polyester film having a thickness of 23 μm an ethylene acrylate copolymer (MW 50,000)/polyester dispersion (2:1) is applied as an adhesion promoter. The imprint is subsequently applied utilizing the Indigo process, which is provided in precise register with a heat-stable overcoat lacquer comprised of an ethylene acrylate copolymer (MW 50,000)/polyester dispersion (2:1) with 0.5% of polyfunctional aziridine.

### Example 2

After the heat-stable overcoat lacquer has cured completely, the film imprinted on one side and produced according to Example 1 is coated on the back side with the adhesion promoter. The imprint is subsequently applied utilizing the digital print process, on which, again, an adhesion promoter and subsequently a heat-seal lacquer are applied.

1. Imprinted sheet material for container coverings, wherein the outside of a carrier sheet a thermoplastic adhesion promoter is applied, subsequently the appropriate imprint is applied, whereupon the imprint in those regions, in which heat protection is required, a lacquer of similar composition is applied by means of a register-controlled method, a portion of the curing agent comprised in the lacquer or applied separately, migrates into the printing ink or the adhesion promoter, respectively, leading to cross-linking and/or on the side facing the fill good an adhesion promoter is applied and thereon an imprint, whereupon onto the printing ink an adhesion promoter is applied and in the above defined regions a heat-seal lacquer.

2. Sheet material as claimed in claim 1, wherein each imprint is applied utilizing the digital print process.

3. Sheet material as claimed in claim 2, wherein the imprint is applied utilizing the Indigo process.

4. Sheet material as claimed in claim 1, wherein onto the sheet material concurrent with the imprint are printed registration and control lines.

5. Sheet material as claimed in claim 1, wherein before the adhesion promoter is applied, registration and control lines are printed onto the material.

6. Sheet material as claimed in claim 1, wherein the adhesion promoter is applied with register and gage-pin precision in those regions, onto which subsequently the imprint is applied.

7. Sheet material as claimed in claim 1, wherein the overcoat lacquer is heat stable.

8. Sheet material as claimed in claim 1, wherein the overcoat lacquer is comprised of an ethylene acrylate copolymer dispersion with an average molecular weight of approximately 22,000 to 150,000 or a mixture of this dispersion with a polyester, polyvinyl acetate, polyacrylate or polyamide in a mixing ratio of 9:1 to 1:1 with respect to the ethylene acrylate copolymer.

9. Sheet material as claimed in claim 1, wherein the overcoat lacquer comprises 0.5%-10% of a curing agent.

10. Sheet material as claimed in claim 1, wherein the curing agent is applied after the overcoat lacquer has been applied.

11. Sheet material as claimed in claim 1, wherein the curing agent is a polyfunctional aziridine or a melamine resin.

12. Sheet material as claimed in claim 1, wherein the overcoat lacquer, and optionally the curing agent, is applied in register and gage-pin precision with respect to the previously applied imprint.

13. Sheet material as claimed in claim 1, wherein the thermoplastic adhesion promoter is pigmented.

14. Sheet material as claimed in wherein, following the heat-seal process or the packaging process, the sheet material is imprintable.

15. Method of using the sheet material as claimed in one claim 1, optionally after it is cut to size and/or stamped, as container covering for food and nutritional items, pharmaceutical and/or cosmetic products, cleaning agents, chemicals and the like.
